(19) United States
(12) Patent Application Publication
(10) Pub. No.: US 2010/0071415 A1
(43) Pub. Date: Mar. 25, 2010

(54) METHOD FOR PRODUCING ANTIMICROBIAL OR ANTIBACTERIAL GLASSES OR GLASS CERAMICS

(75) Inventors: Hans-Juergen Voss, Vorstetten (DE); Harald Selig, Dessau (DE)

Correspondence Address: LERNER GREENBERG STEMER LLP, P O BOX 2480, HOLLYWOOD, FL, 33022-2480, US

(73) Assignee: TROVOTECH GMBH, Wolfen (DE)

(21) Appl. No.: 12/303,026

(22) PCT Filed: May 30, 2007
(86) PCT No.: PCT/EP2007/004752

§ 371 Date: Dec. 9, 2009

(30) Foreign Application Priority Data
Jun. 1, 2006 (DE) 10 2006 026 033.3

(51) Int. Cl. C03B 19/08

(52) U.S. Cl. 65/22

(57) ABSTRACT

A method of producing antimicrobial or antibacterial glass particles, wherein known starting materials are fused, broken or powdered, fed to an extruder, fused therein with addition of defined dose of foaming agents, the foaming agents being introduced into the molten glass by the building pressure, the molten glass being then foamed to give a closed-pore foam on a subsequent pressure reduction to increase surface area and the foam subsequently subjected to a comminution process. The glass particles generated in the comminution process become antimicrobial or antibacterial during an ion exchange or the antimicrobial or antibacterial properties thereof are increased as a result of the ion exchange.

The invention relates to the use of a method for production of antimicrobial or antibacterial glasses or glass ceramics.

Glasses with antimicrobial or antibacterial properties are sufficiently known and have been included in a large number of recipes.

Depending on their recipes, glasses with antimicrobial or antibacterial properties have been used in cosmetics, in medical products or preparations, in plastic materials or polymers, in the paper industry, for the preservation of paints, lacquers and plasters or deodorant products in cleansing agents, for disinfection or similar purposes.

The antimicrobial or antibacterial effect is caused by the release of metal ions. This results in the exchange of alkaline ions which will increase pH value and exert an osmotic effect on micro-organism. In most cases such a pH value increase does not suffice to achieve the desired effect.

Other released metal ions also have an antimicrobial or antibacterial effect. This especially relates to silver, copper and zinc. Some other heavy metal ions also result in a synergetic increase of the antibacterial effect.

In some glasses, as described in DE 102 13 630 A1, for instance, the antimicrobial property of the glass is achieved by some reaction on the glass surface. An exchange of alkali constituents of the glass by H⁺ ions of the aqueous medium takes place on the glass surface. The antimicrobial effect is caused by an increase of the pH value and the osmotic effect on micro-organisms, among other causes.

In DE 101 41 117 A1, an antimicrobial and preserving silicate glass which will only release few heavy metals is described. Said glass is not water-soluble. The effect is mainly caused by ions and ion release respectively, involving surface reaction, pH increase and metal ion release.

In DE 101 41 230 A 1, a glass with antimicrobial effect for being added to paints is described, which is non-toxic for human beings and achieves a preserving effect at the same time.

In U.S. Pat. No. 5,290,544 glasses for applications with cosmetic products are described. These glasses will dissolve in water due to their chemical composition as they have a low SiO₂ content and a high B₂O or high P₂O₅ content. The Ag and/or Cu ions contained in it are being released, the result being an antibacterial effect.

In U.S. Pat. No. 6,143,318 again, antimicrobial glasses are described. These glasses obtain their antimicrobial effect from the copper, silver and zinc used in it, among other causes. These antimicrobial glasses can however not be reduced to powder in aqueous media due to their low hydrolytic stability.

DE 10 2004 022 779.9 describes a procedure for the production of antimicrobial glass by means of an extruder. Some antimicrobial glass or known basic materials for antimicrobial glasses are melted down in the extruder and mixed and foamed with additional heavy metals or substances with an antimicrobial effect.

A disadvantage of all of the preceding technical solutions is the fact that said recipes are rather difficult to produce. It is necessary to integrate heavy metal or noble metal oxides, which eventually trigger or increase the antimicrobial or antibacterial effect, into the glass for this purpose. Any too low concentration of these metal ions will have the result that the antimicrobial or antibacterial effect is only minor or is not achieved at all. This is especially true after longer periods of time.

It is known that the introduction of noble metals in molten glass is only practicable to a limited extent. In a mechanical glass mixture, a concentration of silver salts must for example not exceed 0.003-0.1 wt. %. Any excess of silver concentration will lead to an over-saturation of silver in the molten glass, and silver will precipitate in its elementary structure.

The mechanical glass mixture should be molten in an oxidizing atmosphere otherwise the silver ions are being reduced, which eventually leads to silver deposit. A homogenous distribution of silver or silver ions in molten glass is therefore impossible or only possible with expensive equipment.

State of the art is the supplementary incorporation of silver into the structure of solid glass, for instance, which can be done in two ways. One way is the exchange of ions, the other the implantation of silver ions by electrical fields. Both approaches achieve subsequent doping on the solid glass at its surface only.

Such a subsequent doping process can however generate substantially higher silver ion concentrations on the glass surface than any one in the molten glass during glass production.

The penetration depth of exchanged ions is in the micron range and highly depends on the structure and composition of the glass surface. Ion exchange will also be affected by the tin-containing coating of float glasses or surface modifications resulting from the touching of the molten glass or from glass rolling or drawing processes.

Both the quantity and penetration depth and the speed of the ions to be exchanged will depend on the temperature and period of treatment as well as on the composition and concentration of the ions to be exchanged (glass and molten salt bath).

The described requirements will not only apply for the ion exchange with silver, but also for the exchange of other ions, such as sodium, potassium, rubidium, lithium, thallium, copper, caesium, thorium, antimony, lead etc.

It is the purpose of the invention to provide a method for the production of antimicrobial or antibacterial glass particles which excludes any influence of the glass surface by external touch during its hot condition, e.g. tin bath during float glass production, or the touch of rolls when glasses are being rolled or drawn. It is another purpose of the invention to provide an untroubled glass surface which is neither affected by a tin-containing coat (float glass production) nor by any other facts.

The task is fulfilled by the method described in the claims 1 through 11 and explained in detail below.

In order to achieve maximum silver ion concentration in the glass it is necessary to carry out ion exchange on a large surface area compared to the glass mass. You have to multiply the glass surface area compared to its mass by several numbers, therefore creating the prerequisite for an effective ion exchange.

When using the antimicrobial or antibacterial function of glass at a later time, a maximised surface area, i.e. a platelet, will be decisive.

You can meet this requirement both with the intermediate process of generating glass foam and by platelet-like structures.

The starting materials for the production of antimicrobial or antibacterial glass foam or the production of glass platelet-like structures are fused, broken, or powdered, fed to an extruder, fused or melted open therein with addition of a specific dose of foaming agent.

The foaming agent may be carbon dioxide, argon or other gases. These gases should however be capable of dissolving in the glass or being mixed in well in the extruder at high temperatures. These gaseous constituents must be introduced into the molten mass to their maximum at the pressure prevailing in the extruder.

You can also use substances as foaming agents which case a foaming process by changing their condition. If you use water as foaming agent, for instance, it will evaporate at high temperatures, thus being dissolved in the glass by the pressure existing in the extruder.

The foaming agents can be dissolved both physically (due to the pressure and temperature) and chemically (in the case of water), or only physically (in the case of argon, for instance).

You can also use foaming agents which trigger gas formation by a chemical reaction.

The gases generated are absorbed in the molten mass in the extruder at the conditions specified.

A chemical foaming agent is sodium carbonate, for instance, which when combined with silicon dioxide will lose carbon dioxide at these temperatures.

Na₂CO₃+SiO₂ Na₂SiO₃+CO₂

In solid glass, the existing sodium can be exchanged by ion exchange with silver, for instance.

You can also add other substances, such as Na₂O, to the basic materials or the extruder in order to facilitate or improve ion exchange.

Once the molten mass is stress-relieved after the extruding process, the dissolved gases are released and the molten mass starts foaming. Depending on the foaming agents used and the temperatures at which the molten glass leaves the extruder and the pressure reduction starts, a number of different foams can be generated. Said foam generation also depends on the type and quantity of the foaming agents.

The different foaming agents used, such as water, carbon dioxide, argon etc. may cause the formation of different structures of bubbles in the foam.

The purpose of foam generation is to achieve a maximum size of bubbles with thin walls. At advantageous conditions, wall thickness less than 1 micron can be created.

Wall thickness and the size of bubbles within the foam can be influenced in particular by the quantity of foaming agent. The more foaming agent to be dissolved in the molten mass you add to the extruder, the larger the size and the thinner the wall of the bubbles once the pressure is reduced after extruding. This case has the disadvantage that the pressure in the extruder will raise when high quantities of foaming agents are added in order to fully dissolve the gas in the glass.

Foam formation after extruding will also depend on the viscosity of the molten mass when pressure is decreased. An optimum of foam formation is only possible with a specific viscosity. This specified viscosity is attributed to a defined temperature.

Depending on the glass composition, the melting range is also a function of temperature. This means that any modification of composition of the molten mass will result in another temperature for optimum foam formation attributed to a specific viscosity.

It is possible to generate open-pore foams at certain conditions (type of foaming agent, foaming agent quantity, temperature, pressure etc.). Such open-pore foams have a very large surface area and can also be subjected to ion exchange. Said very large surface area of the glass facilitates the exchange of larger quantities of ions, such as silver, than is possible on a closed body.

Another embodiment of the method according to the invention provides for the breaking or grinding of the produced glass foam. The thin glass walls of the individual bubbles will generate a substance with a high surface-mass ratio. You can separate sheet-shaped parts (bubble walls) from ball-shaped ones (pendentives between bubbles) by sizing. In this case, ion exchange, with silver, for instance, can also be carried out.

Another procedural step is the completion of ion exchange according to the known procedure.

If the bubble wall thickness is lower 1 micron, as described above, and the ion exchange is performed, the result is a substance wherein silver ions, for instance, are almost evenly spaced.

In another embodiment of the method according to the invention, you can add to the extruder an antimicrobial glass. After the foaming process and resulting surface area increase, you can increase the antimicrobial effect during ion exchange by introducing other ions, such as silver for instance.

1-11. (canceled)

12. A method for producing antimicrobial or antibacterial glass particles, which comprises:
feeding starting materials in fused, broken, or powdered form to an extruder;
melting the staring materials in the extruder with concurrent metered addition of foaming agents, wherein the foaming agents are introduced into the molten glass by a building pressure;
foaming the molten glass to form a closed-pore foam during a subsequent pressure reduction to increase a surface area;
subsequently subjecting the foam to a comminution process to form glass particles, and subjecting the glass particles to an ion exchange, wherein the glass particles become antimicrobial or antibacterial, or the antimicrobial or antibacterial properties of the glass particles are increased as a result of the ion exchange.

13. The method according to claim 12, which comprises using gaseous substances as foaming agents.

14. The method according to claim 12, which comprises using substances that trigger the foam generation by a change of a state of aggregation thereof as the foaming agents.

15. The method according to claim 12, wherein the foaming agents are chemical compounds or elements that trigger gas formation and therefore an inflation process by chemical reactions.

16. The method according to claim 12, which comprises adding some substances improving ion exchange to the basic materials prior to the step of feeding the materials into the extruder.

17. The method according to claim 12, which comprises adding substances that will be exchanged during ion exchange to the basic materials prior to the step of feeding the materials into the extruder.

18. The method according to claim 12, which comprises adding substances improving ion exchange to the extruder in addition to the basic materials.

19. The method according to claim 12, which comprises adding substances that will be exchanged during ion exchange to the extruder in addition to the basic materials.

20. The method according to claim 12, which comprises subjecting glasses or glass ceramics thus produced to thermal treatment.

21. A method for producing antimicrobial or antibacterial glass particles, which comprises:
feeding starting materials in fused, broken, or powdered form to an extruder;
melting the staring materials in the extruder with concurrent metered addition of foaming agents, wherein the foaming agents are introduced into the molten glass by a building pressure;
foaming the molten glass to form an open-pore foam during a subsequent pressure reduction to increase a surface area;
subsequently subjecting the foam to a comminution process to form glass particles, and subjecting the glass particles to an ion exchange, wherein the glass particles become antimicrobial or antibacterial, or the antimicrobial or antibacterial properties of the glass particles are increased as a result of the ion exchange.

22. The method according to claim 21, which comprises using gaseous substances as foaming agents.

23. The method according to claim 21, which comprises using substances that trigger the foam generation by a change of a state of aggregation thereof as the foaming agents.

24. The method according to claim 21, wherein the foaming agents are chemical compounds or elements that trigger gas formation and therefore an inflation process by chemical reactions.

25. The method according to claim 21, which comprises adding some substances improving ion exchange to the basic materials prior to the step of feeding the materials into the extruder.

26. The method according to claim 21, which comprises adding substances that will be exchanged during ion exchange to the basic materials prior to the step of feeding the materials into the extruder.

27. The method according to claim 21, which comprises adding substances improving ion exchange to the extruder in addition to the basic materials.

28. The method according to claim 21, which comprises adding substances that will be exchanged during ion exchange to the extruder in addition to the basic materials.

29. The method according to claim 21, which comprises subjecting glasses or glass ceramics thus produced to thermal treatment.

30. A method for producing antimicrobial or antibacterial glass particles, which comprises:
feeding starting materials in fused, broken, or powdered form to an extruder;
melting the staring materials in the extruder with concurrent metered addition of foaming agents, wherein the foaming agents are introduced into the molten glass by a building pressure;
foaming the molten glass to form an open-pore foam during a subsequent pressure reduction to increase a surface area;
subjecting the open-pore foam to an ion exchange to render same anti-microbial or antibacterial or to increase an antimicrobial or antibacterial property thereof; and
subsequently subjecting the foam to a comminution process to form antimicrobial or antibacterial glass particles.

31. The method according to claim 30, which comprises using gaseous substances as foaming agents.

32. The method according to claim 30, which comprises using substances that trigger the foam generation by a change of a state of aggregation thereof as the foaming agents.

33. The method according to claim 30, wherein the foaming agents are chemical compounds or elements that trigger gas formation and therefore an inflation process by chemical reactions.

34. The method according to claim 30, which comprises adding some substances improving ion exchange to the basic materials prior to the step of feeding the materials into the extruder.

35. The method according to claim 30, which comprises adding substances that will be exchanged during ion exchange to the basic materials prior to the step of feeding the materials into the extruder.

36. The method according to claim 30, which comprises adding substances improving ion exchange to the extruder in addition to the basic materials.

37. The method according to claim 30, which comprises adding substances that will be exchanged during ion exchange to the extruder in addition to the basic materials.

38. The method according to claim 30, which comprises subjecting glasses or glass ceramics thus produced to thermal treatment.
